(19) United States
(12) Patent Application Publication
(10) Pub. No.: US 2026/0147427 A1
(43) Pub. Date: May 28, 2026

(54) TOUCH RESPONSE METHOD, TERMINAL, AND STORAGE MEDIUM

(71) Applicant: REALME MOBILE TELECOMMUNICATIONS (SHENZHEN) CO., LTD., Shenzhen (CN)

(72) Inventor: Minghui Wei, Shenzhen (CN)

(73) Assignee: REALME MOBILE TELECOMMUNICATIONS (SHENZHEN) CO., LTD., Shenzhen (CN)

(21) Appl. No.: 19/421,646

(22) Filed: Dec. 16, 2025

Related U.S. Application Data
(63) Continuation of application No. PCT/CN2024/127662, filed on Oct. 28, 2024.

(30) Foreign Application Priority Data
Nov. 2, 2023 (CN) 202311455233.6

(51) Int. Cl. G06F 3/041; G06F 3/0485; G06F 3/04883

(52) U.S. Cl. CPC G06F 3/04166; G06F 3/0485; G06F 3/04883

(57) ABSTRACT

The present application relates to the field of touch response, and provides a touch response method and apparatus, a device, a storage medium, and a product. The method includes: in a case where a first touch operation is detected, identifying a touch scenario corresponding to the first touch operation; acquiring a touch filtering parameter value corresponding to the touch scenario, the touch filtering parameter value includes at least one of a touch-point filtering parameter value and a trajectory filtering parameter value; obtaining a second touch operation by performing a filtering process on the first touch operation on the basis of the touch filtering parameter value; and responding to the second touch operation.

### CROSS-REFERENCE TO RELATED APPLICATIONS

The present application is a continuation of International (PCT) Patent Application No. PCT/CN2024/127662 filed on Oct. 28, 2024, which claims foreign priority to Chinese Patent Application No. 202311455233.6, filed on Nov. 2, 2023, the contents of which are herein incorporated by reference in their entireties.

### TECHNICAL FIELD

The present disclosure relates to the field of touch screen technologies, and in particular to a touch response method, a terminal, and a storage medium.

### BACKGROUND

Currently, terminals such as mobile phones, smart watches, or tablet computers are equipped with touch screens, allowing users to perform touch operations on the touch screens to trigger commands for the terminals. The terminals then respond to the user's touch operations to execute the commands triggered by the user. For example, when the users use mobile phones to browse short videos, they may perform sliding operations on the touch screens to trigger switch commands for the mobile phones. The terminals may switch the short videos currently being viewed by the users on the basis of the sliding operations triggered by the users.

### SUMMARY

Embodiments of the present disclosure provide a touch response method, a terminal and a storage medium. The technical solutions are as follows:

In one aspect, a touch response method is provided. The method includes:
in case where a first touch operation is detected, identifying a touch scenario corresponding to the first touch operation;
acquiring a touch filtering parameter value corresponding to the touch scenario, the touch filtering parameter value includes at least one of a touch-point filtering parameter value and a trajectory filtering parameter value, the touch-point filtering parameter value is configured to perform filtering on a touch-point of the first touch operation, the trajectory filtering parameter value is configured to perform filtering on a trajectory of the first touch operation;
obtaining a second touch operation by performing a filtering process on the first touch operation on the basis of the touch filtering parameter value; and
responding to the second touch operation.

In another aspect, a terminal is provided. The terminal includes one or more processors and one or more memories, at least one piece of program code is stored in the one or more memories, and the at least one piece of program code is loaded and executed by the one or more processors to implement the above-mentioned touch response method.

In another aspect, a non-transitory computer-readable storage medium is provided. At least one piece of program code is stored in the non-transitory computer-readable storage medium, and the at least one piece of program code is loaded and executed by a processor to implement the above-mentioned touch response method.

### BRIEF DESCRIPTION OF THE DRAWINGS

FIG. 1 is a schematic flowchart of a touch response method according to an exemplary embodiment of the present disclosure.

FIG. 2 is a schematic flowchart of a touch response method according to an exemplary embodiment of the present disclosure.

FIG. 3 is a schematic flowchart of a touch response method in the related art according to an exemplary embodiment of the present disclosure.

FIG. 4 is a schematic flowchart of a touch response method according to an exemplary embodiment of the present disclosure.

FIG. 5 is a schematic flowchart of a touch response method according to an exemplary embodiment of the present disclosure.

FIG. 6 is a schematic flowchart of a touch response method according to an exemplary embodiment of the present disclosure.

FIG. 7 is a schematic flowchart of a touch response method according to an exemplary embodiment of the present disclosure.

FIG. 8 is a block diagram of a touch response apparatus according to an exemplary embodiment of the present disclosure.

FIG. 9 is a block diagram of a terminal according to an exemplary embodiment of the present disclosure.

### DETAILED DESCRIPTION

To make the objectives, technical solutions, and advantages of the present disclosure clearer, embodiments of the present disclosure will be described clearly in detail in conjunction with the drawings.

“A plurality of” mentioned herein means two or more than two. “And/or” describes an association relationship between associated objects and indicates that three relationships may exist. For example, “A and/or B” may indicate the following three cases: A exists alone, both A and B exist, and B exists alone. The character “/” generally indicates that the associated objects before and after it are in an “or” relationship.

It should be noted that, the information (including but not limited to user equipment information, user personal information, etc.), data (including but not limited to data used for analysis, stored data, displayed data, etc.), and signals involved in the present disclosure are all authorized by users or fully authorized by all relevant parties. Furthermore, the collection, use, and process of relevant data must comply with applicable laws, regulations, and standards in the relevant countries and regions. For example, the touch scenarios, first touch operation, touch instructions (including first touch instruction and second touch instruction), first historical touch data, second historical touch data, touch filtering parameter values, scenario images, and sliding distance threshold involved in the present disclosure are all obtained with full authorization.

In the embodiments of the present disclosure, the following technical solutions are provided:

A touch response method, including:
in case where a first touch operation is detected, identifying a touch scenario corresponding to the first touch operation;
acquiring a touch filtering parameter value corresponding to the touch scenario, the touch filtering parameter value includes at least one of a touch-point filtering parameter value and a trajectory filtering parameter value, the touch-point filtering parameter value is configured to perform filtering on a touch-point of the first touch operation, the trajectory filtering parameter value is configured to perform filtering on a trajectory of the first touch operation;
obtaining a second touch operation by performing a filtering process on the first touch operation on the basis of the touch filtering parameter value; and
responding to the second touch operation.

In some embodiments, the acquiring the touch filtering parameter value corresponding to the touch scenario, includes:
acquiring the touch filtering parameter value corresponding to the touch scenario from a pre-stored correspondence between a scenario identification and the touch filtering parameter value on the basis of the scenario identification of the touch scenario.

In some embodiments, the method further includes:
for any one of a plurality of preset touch scenarios, acquiring first historical touch data of a currently logged-in account in the touch scenario;
determining the touch filtering parameter value of the currently logged-in account in the touch scenario on the basis of the first historical touch data; and
associatively storing the scenario identification of the touch scenario and the touch filtering parameter value in the correspondence between the scenario identification and the touch filtering parameter value.

In some embodiments, the acquiring the touch filtering parameter value corresponding to the touch scenario from the pre-stored correspondence between the scenario identification and the touch filtering parameter value on the basis of the scenario identification of the touch scenario, includes:
in a case where the touch scenario is a game scenario, determining an area type of a touch area of the first touch operation in the game scenario; and
acquiring the touch filtering parameter value corresponding to the game scenario from a pre-stored correspondence among the scenario identification, the area type, and the touch filtering parameter value on the basis of the scenario identification of the game scenario and the area type.

In some embodiments, the determining the area type of the touch area of the first touch operation in the game scenario, includes:
obtaining a scenario image by capturing a screenshot of the game scenario;
identifying a core icon of the scenario image through an image identification model; and
determining the area type corresponding to the core icon.

In some embodiments, the method further includes:
for any one of a plurality of preset area types in the game scenario, acquiring second historical touch data of the currently logged-in account for the touch operation triggered in an area corresponding to the area type.

determining the touch filtering parameter value of the currently logged-in account for the touch operation triggered in the area corresponding to the area type on the basis of the second historical touch data; and

associatively storing the scenario identification of the game scenario, the area type, and the touch filtering parameter value in the correspondence among the scenario identification, the area type, and the touch filtering parameter value.

In some embodiments, the responding to the second touch operation, includes:
in a case where the second touch operation is a sliding operation, acquiring a sliding distance threshold corresponding to the currently logged-in account; and
in a case where a sliding distance of the sliding operation exceeds the sliding distance threshold, responding to the sliding operation.

In some embodiments, the method further includes:
acquiring a plurality of historical sliding operations of the currently logged-in account; and
determining the sliding distance threshold corresponding to the currently logged-in account on the basis of sliding distances of the plurality of historical sliding operations.

In some embodiments, the obtaining the second touch operation by performing the filtering process on the first touch operation on the basis of the touch filtering parameter value, includes:
the touch filtering parameter value includes the touch-point filtering parameter value; in a case where a distance between an edge touch-point and a center touch-point of the first touch operation is less than a touch-point distance threshold represented by the touch-point filtering parameter value, the second touch operation obtained by performing the filtering process on the first touch operation is a click operation; and
in a case where the distance between the edge touch-point and the center touch-point of the first touch operation is not less than the touch-point distance threshold represented by the touch-point filtering parameter value, the second touch operation obtained by performing the filtering process on the first touch operation is a sliding operation.

In some embodiments, the obtaining the second touch operation by performing the filtering process on the first touch operation on the basis of the touch filtering parameter value, includes:
the touch filtering parameter value includes the trajectory filtering parameter value; obtaining the second touch operation by performing a smoothing process on a sliding trajectory of the first touch operation on the basis of the trajectory filtering parameter value.

In the embodiments of the present disclosure, different touch filtering parameter values corresponding to different touch scenarios are set, so that the touch filtering parameter value adaptive to the current touch scenario may be acquired. That is, the acquired touch filtering parameter value is more rational. Therefore, the effect of performing the filtering process on the first touch operation on the basis of the touch filtering parameter value may be improved, and thereby further improving the effect of responding to the obtained second touch operation.

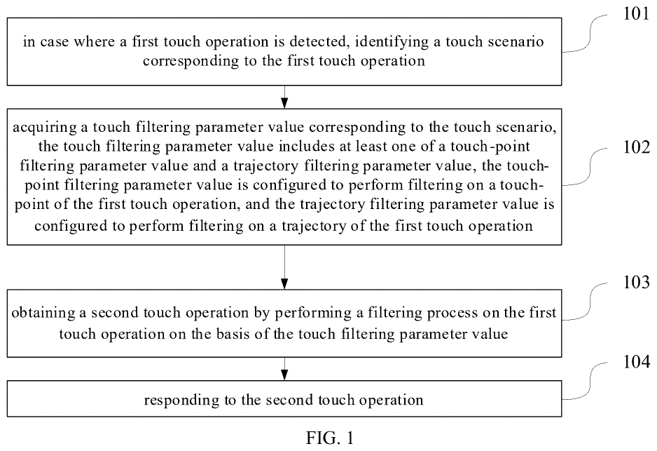

Please refer to FIG. 1, which illustrates a schematic flowchart of a touch response method according to an exemplary embodiment of the present disclosure. The execution entity of the method is a terminal, and the method includes:

The operation 101: in case where a first touch operation is detected, identifying a touch scenario corresponding to the first touch operation.

The first touch operation may be any one of touch operations acting on the touch screen of the terminal. For example, the first touch operation may be a click operation or a sliding operation. The touch scenario may be a game scenario or a daily scenario. The game scenario refers to a scenario in a case where an application currently running in the foreground is a game application. The daily scenario is other scenario besides the game scenario, that is, the daily scenario refers to a scenario in a case where the application currently running in the foreground is a non-game application. The daily scenario is further divided into a full-screen gesture scenario (which may also be known as a full-screen daily scenario) and a non-full-screen gesture scenario (which may also be known as a non-full-screen daily scenario). The non-full-screen gesture scenario refers to a scenario in a case where a command is triggered for the terminal by clicking a virtual button, that is, the first touch operation in the non-full-screen gesture scenario is often a click operation. The full-screen gesture scenario refers to a scenario in a case where a command is triggered for the terminal through a touch operation, that is, the first touch operation in the full-screen gesture scenario may be either a click operation or a sliding operation.

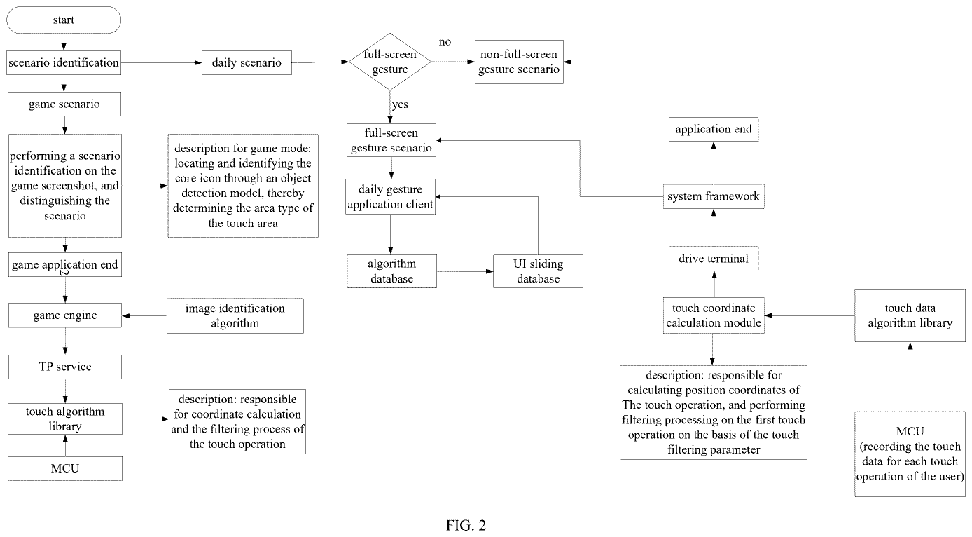

In some embodiments, the terminal identifies the touch scenario corresponding to the first touch operation through the application running in the foreground. The process may be as follows: in a case where the application currently running in the foreground is the game application, the terminal may determine that the touch scenario corresponding to the first touch operation is the game scenario; in a case where the application currently running in the foreground is the non-game application, the terminal may determine that the touch scenario corresponding to the first touch operation is the daily scenario. Furthermore, the daily scenario is further divided into the full-screen gesture scenario and the non-full-screen gesture scenario. Correspondingly, after the terminal determines that the touch scenario corresponding to the first touch operation is a daily scenario, determining whether a full-screen gesture is enabled on the terminal; in a case where the full-screen gesture is enabled on the terminal, determining the daily scenario is the full-screen gesture scenario, that is, the touch scenario corresponding to the first touch operation is the full-screen gesture scenario; in a case where a non-full-screen gesture is enabled on the terminal, determining the daily scenario is the non-full-screen gesture scenario, that is, the touch scenario corresponding to the first touch operation is the non-full-screen gesture scenario. This process may be referred to in FIG. 2. The full-screen gesture refers to the use of specific gesture operation on a full-screen device to replace traditional virtual buttons or physical buttons. The non-full-screen gesture refers to an operational method of traditional virtual buttons or physical buttons.

In the embodiments of the present disclosure, the touch scenario corresponding to the first touch operation is identified through identifying the application currently running in the foreground as described above, and the operation is simple, thereby improving the efficiency of touch scenario identification.

In other embodiments, the terminal may also identify the touch scenario corresponding to the first touch operation through a scenario identification model. The process may be as follows: obtaining an interface screenshot by capturing a screenshot of an interface currently displayed, and inputting the interface screenshot into the scenario identification model to output the touch scenario corresponding to the first touch operation. Since the scenario identification model is trained on the basis of a large amount of sample data, the scenario identification model may have a relatively high identification accuracy. That is, using the scenario identification model to identify the touch scenario corresponding to the first touch operation may improve the accuracy of touch scenario identification.

In some embodiments, in a case where the first touch operation is detected, the terminal identifies the touch scenario corresponding to the first touch operation in real-time. In other embodiments, in a case where the terminal detects a change in the interface, the terminal identifies the touch scenario corresponding to the current interface, and then updates the stored touch scenario for the current interface. Correspondingly, in a case where the first touch operation is detected in this operation, the terminal acquires the stored touch scenario corresponding to the current interface.

The operation 102: acquiring a touch filtering parameter value corresponding to the touch scenario, the touch filtering parameter value includes at least one of a touch-point filtering parameter value and a trajectory filtering parameter value, the touch-point filtering parameter value is configured to perform filtering on a touch-point of the first touch operation, and the trajectory filtering parameter value is configured to perform filtering on a trajectory of the first touch operation.

The touch-point filtering parameter value represents the touch-point distance threshold. In a case where the distance between the edge touch-point and the center touch-point of the first touch operation exceeds the touch-point distance threshold represented by the touch-point filtering parameter value, the first touch operation is the sliding operation. In a case where the distance between the edge touch-point and the center touch-point of the first touch operation does not exceeds the touch-point distance threshold represented by the touch-point filtering parameter value, the first touch operation is the click operation. That is, the touch-point filtering parameter value is configured to determine whether a touch operation is a point operation (a click operation) or a line operation (a sliding operation). The first touch operation is often triggered by a user's finger, so the touch area of the first touch operation is a finger-shaped area. Consequently, there are a plurality of edge touch-points of the first touch operation. In the embodiments of the present disclosure, the edge touch-point may be any one of the plurality of edge touch-points, or may be the farthest of the plurality of edge touch-points. The farthest edge touch-point refers to the edge touch-point that is farthest from the center touch-point among the plurality of edge touch-points of the first touch operation.

Furthermore, the touch-point filtering parameter value may also be referred to as a lock-point parameter value. The trajectory filtering parameter value may be a smoothing processing parameter value, and the trajectory filtering parameter value is configured to perform a smoothing filtering process on the sliding trajectory of the sliding operation. Additionally, the trajectory filtering parameter value may also be referred to as a follow-up feeling parameter value or simply referred to as a filtering parameter value.

In the embodiments of the present disclosure, different touch filtering parameter values corresponding to different touch scenarios are set, so that a touch filtering parameter value adaptive to the current touch scenario may be acquired, improving the accuracy of the acquired touch filtering parameter value.

Furthermore, different touch scenarios may also correspond to different touch filtering parameters. In some embodiments, in a case where the touch scenario is the game scenario, both click operation and sliding operation are involved in the game scenario. For example, the user may select equipment by the click operation, and control the movement of a virtual object by the sliding operation. Therefore, the touch filtering parameters corresponding to the game scenario include the touch-point filtering parameter and the trajectory filtering parameter. In a case where the touch scenario is the non-full-screen gesture scenario, the user typically triggers commands for the terminal by clicking virtual buttons, that is, the touch operation involved in the non-full-screen gesture scenario is the click operation. Consequently, the touch filtering parameter corresponding to the non-full-screen gesture scenario is the touch-point filtering parameter. In a case where the touch scenario is a full-screen gesture scenario, both click operation and sliding operation are involved in the full-screen gesture scenario. For example, the user browsing short videos in the full-screen gesture scenario may perform a like operation by the click operation and switch the currently viewed short video by the sliding operation. Therefore, the touch filtering parameters corresponding to the full-screen gesture scenario include the touch-point filtering parameter and the trajectory filtering parameter.

The operation 103: obtaining a second touch operation by performing a filtering process on the first touch operation on the basis of the touch filtering parameter value.

In some embodiments, the touch filtering parameter value includes the touch-point filtering parameter value, and the touch-point filtering parameter value indicates the touch-point distance threshold. In a case where the distance between the edge touch-point and the center touch-point of the first touch operation is less than the touch-point distance threshold represented by the touch-point filtering parameter value, the second touch operation obtained by performing the filtering process on the first touch operation is the click operation. In a case where the distance between the edge touch-point and the center touch-point of the first touch operation is not less than the touch-point distance threshold represented by the touch-point filtering parameter value, the second touch operation obtained by performing the filtering process on the first touch operation is the sliding operation. Furthermore, before performing the filtering process on the first touch operation, the terminal first tracks the first touch operation. Upon determining that the touch-point of the first touch operation is lifted (i.e., finger lift), the complete first touch operation is obtained at this time, and the terminal then obtains the second touch operation by performing the filtering process on the first touch operation.

In other embodiments, the touch filtering parameter value includes the trajectory filtering parameter value, and the trajectory filtering parameter value is the smoothing processing parameter value. Obtaining the second touch operation by performing a smoothing process on the sliding trajectory of the first touch operation on the basis of the trajectory filtering parameter value (the smoothing processing parameter value).

In the embodiments of the present disclosure, for the click operation, performing the filtering process on the click touch operation by the touch-point filtering parameter value may enable accurate identification of the click operation. For the sliding operation, performing the filtering process on the sliding touch operation by the trajectory filtering parameter value may improve the smoothness of the sliding trajectory.

The operation 104: responding to the second touch operation.

In some embodiments, the second touch operation is the click operation. Determining a first touch instruction corresponding to the click operation on the basis of the touch scenario and a touch-point position of the click operation, and executing the first touch instruction to respond to the second touch operation. For example, a return instruction may be executed in a case where the second touch operation is a click on a back button. In other embodiments, the second touch operation is the sliding operation. Determining a second touch instruction corresponding to the sliding operation on the basis of the touch scenario, and executing the second touch instruction to respond to the second touch operation. For example, in a case where the touch scenario is the full-screen gesture scenario and the user is browsing short videos, the second touch operation is triggered by the user to trigger a switch instruction for the terminal, thereby the terminal switches the currently playing short video on the basis of the switch instruction.

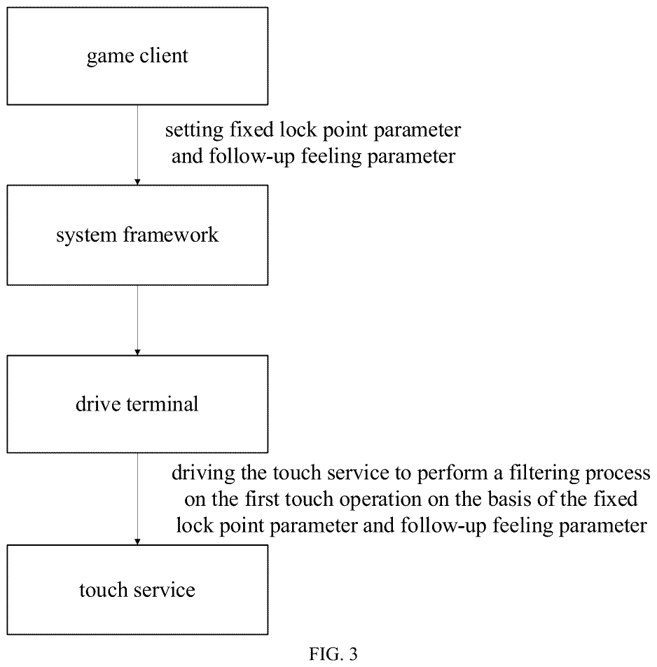

Please refer to FIG. 3. Scenarios are not distinguished in the related art. That is, a game application sets fixed touch-point filtering parameter (lock-point parameter) and trajectory filtering parameter (follow-up feeling parameter), transmits the touch-point filtering parameter and the trajectory filtering parameter to the touch service through the system framework and drive terminal, and then performs the filtering process on the first touch operation on the basis of the touch-point filtering parameter and trajectory filtering parameter.

In the embodiments of the present disclosure, different touch filtering parameter values corresponding to different touch scenarios are set, so that the touch filtering parameter value adaptive to the current touch scenario may be acquired. That is, the acquired touch filtering parameter value is more rational. Therefore, the effect of performing the filtering process on the first touch operation on the basis of the touch filtering parameter value may be improved, thereby further improving the effect of responding to the obtained second touch operation.

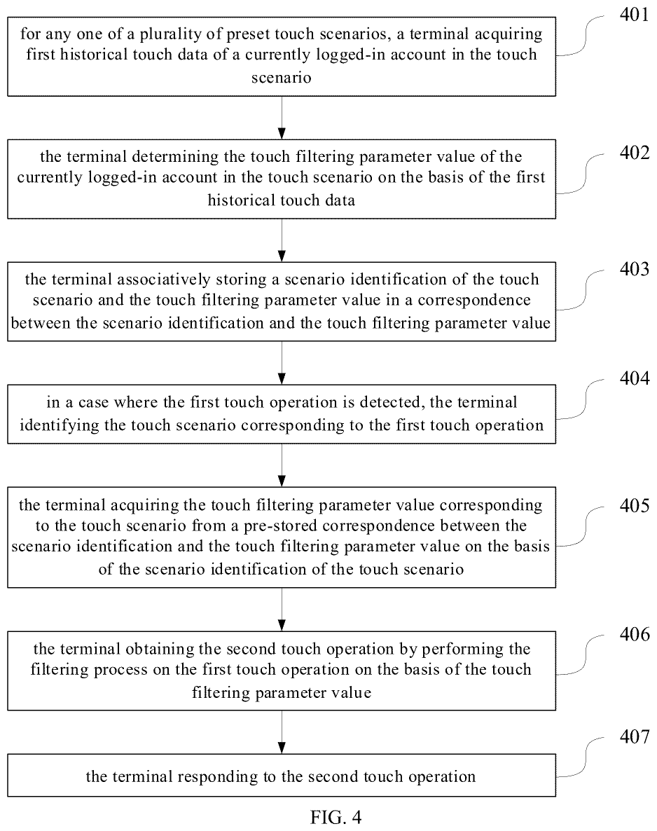

Please refer to FIG. 4, which illustrates a schematic flowchart of a touch response method according to an exemplary embodiment of the present disclosure. The method includes:

The operation 401: for any one of a plurality of preset touch scenarios, a terminal acquiring first historical touch data of a currently logged-in account in the touch scenario.

The plurality of touch scenarios may include the game scenario and the daily scenario. The daily scenario may be further divided into the non-full-screen gesture scenario (which may also be referred to as the non-full-screen daily scenario) and the full-screen gesture scenario (which may also be referred to as the full-screen daily scenario). Therefore, the plurality of touch scenarios may include the game scenario, the non-full-screen gesture scenario, and the full-screen gesture scenario. In some embodiments, the terminal may acquire all first historical touch data of the currently logged-in account in the touch scenario, thereby enriching the acquired first historical touch data. In other embodiments, the terminal does not acquire all first historical touch data, but instead acquires the most recently generated first historical touch data. That is, the terminal acquires the first touch data generated within a preset duration closest to the current time by the currently logged-in account in the touch scenario, thereby ensuring that the acquired first historical touch data may reflect the user's recent preferences.

In some embodiments, in a case where the currently logged-in account does not have the first historical touch data, the operations 401-403 may be not executed. Instead, a correspondence between a scenario identification and the touch filtering parameter value may be acquired from a server. For the first implementation, the correspondence between the scenario identification and the touch filtering parameter value acquired by the terminal from the server may be a general correspondence. That is, all users may utilize the same correspondence between the scenario identification and the touch filtering parameter value. For the second implementation, the correspondence between the scenario identification and the touch filtering parameter value acquired by the terminal from the server is adapted to the specific user. Correspondingly, the operation of the terminal acquiring the correspondence between the scenario identification and the touch filtering parameter value from the server may be as follows. The terminal sends an acquisition request to the server, and the acquisition request carries the currently logged-in account. The server receives the acquisition request, determines target account information matching the account information of the from a plurality of account information on the basis of the account information of the currently logged-in account, acquires the correspondence between the scenario identification and the touch filtering parameter value corresponding to the target account information, and sends the correspondence between the scenario identification and the touch filtering parameter value corresponding to the target account information to the terminal. The terminal receives the correspondence between the scenario identification and the touch filtering parameter value sent by the server, and executes the operation 404. The correspondence between the scenario identification and the touch filtering parameter value corresponding to the target account information is a correspondence between the scenario identification and the touch filtering parameter value determined on the basis of the historical touch data of the target account.

In the embodiments of the present disclosure, even in a case where the currently logged-in account is in a cold start situation (no historical touch data exists), the correspondence between the scenario identification and the touch filtering parameter value adapted to the currently logged-in account may still be acquired from the server, enriching the application scenarios.

The operation 402: the terminal determining the touch filtering parameter value of the currently logged-in account in the touch scenario on the basis of the first historical touch data.

The first historical touch data include touch data corresponding to the click operation and touch data corresponding to the sliding operation. In some embodiments, the terminal determines the touch-point filtering parameter value of the touch filtering parameter value on the basis of the touch data corresponding to the click operation, and determines the trajectory filtering parameter value of the touch filtering parameter value on the basis of the touch data corresponding to the sliding operation.

The first historical touch data include touch data corresponding to a plurality of click operations. For any click operation, the touch data corresponding to the click operation include position coordinates of the touch area. The terminal determines a distance between the center touch-point and the edge touch-point of the touch area on the basis of the position coordinates of the touch area corresponding to the click operation, determines an average distance on the basis of the distances between the center touch-points and the edge touch-points corresponding to the plurality of click operations, and determines the touch-point filtering parameter value on the basis of the average distance. For example, the terminal takes the average distance as the touch-point filtering parameter value. Alternatively, the terminal obtains the touch-point filtering parameter value by floating the average distance upward to a first preset distance, or obtains the touch-point filtering parameter value by floating the average distance downward to a second preset distance. Both the first preset distance and the second preset distance may be set and modified as necessary. In the embodiments of the present disclosure, the first preset distance and the second preset distance are not specifically limited.

The first historical touch data include touch data corresponding to a plurality of sliding operations. For any sliding operation, the touch data corresponding to the sliding operation include a sliding trajectory. The terminal determines a smoothness of the sliding trajectory of the sliding operation, determines an average smoothness of the smoothness corresponding to the plurality of sliding operations, and determines the trajectory filtering parameter value on the basis of the average smoothness. For example, the terminal may obtain the trajectory filtering parameter value by determining a ratio of a preset smoothness to the average smoothness.

For example, please continue to refer to FIG. 2. A Microcontroller Unit (MCU) of the terminal is configured to record the touch data for each touch operation of the user. That is, the first historical touch data are stored in the MCU. The terminal acquires the first historical touch data from the MCU, and determines the touch filtering parameter value of the currently logged-in account in the touch scenario through a touch data algorithm library. The terminal includes a touch coordinate calculation module. The touch coordinate calculation module is configured to calculate position coordinates of the touch operation, and perform the filtering process on the touch operation, etc. After determining the correspondence between the scenario identification and the touch filtering parameter value, the terminal stores the correspondence or updates the correspondence to the touch coordinate calculation module. The terminal further includes a driver end (kernel input) and a system framework (android input). The touch coordinate calculation module transmits the correspondence to the application end of the non-full-screen gesture scenario and the application end of the full-screen gesture scenario through the driver layer and the system layer. For example, the terminal transmits the touch-point filtering parameter to the application end of the non-full-screen gesture scenario, and transmits the touch-point filtering parameter and the trajectory filtering parameter to the application end of the full-screen gesture scenario.

In the embodiments of the present disclosure, in the daily scenario, in case where the user touches the screen during daily use of the terminal, raw data may be collected by touching, the raw data may be analyzed and recorded, and then the touch-point filtering parameter (lock-point parameter) and the trajectory filtering parameter (filtering parameter) may be calibrated. Therefore, the user may achieve an optimal clicking experience (via filtering on the basis of the lock-point parameter) and follow-up feeling experience (via filtering on the basis of the trajectory filtering parameter).

The operation 403: the terminal associatively storing a scenario identification of the touch scenario and the touch filtering parameter value in a correspondence between the scenario identification and the touch filtering parameter value.

The terminal determines the touch filtering parameter value corresponding to a plurality of touch scenarios on the basis of the above-mentioned method, and associatively stores the scenario identification of the plurality of touch scenarios and the corresponding touch filtering parameter value in the correspondence between the scenario identification and the touch filtering parameter value.

In some embodiments, the operations 401-403 may be executed only once. Subsequently, in a case where the first touch operation is detected, operations 404-407 may be executed directly. In other embodiments, the terminal executes the operations 401-403 periodically at a preset interval, thereby enabling timely updates of the touch filtering parameter value. Therefore, the touch filtering parameter value may remain current, and the accuracy of the touch filtering parameter value may be improved.

The operation 404: in a case where the first touch operation is detected, the terminal identifying the touch scenario corresponding to the first touch operation.

In some embodiments, this operation is identical to the operation 101, and thus is not elaborated herein.

The operation 405: the terminal acquiring the touch filtering parameter value corresponding to the touch scenario from a pre-stored correspondence between the scenario identification and the touch filtering parameter value on the basis of the scenario identification of the touch scenario.

For example, please continue to refer to FIG. 2. In a case where the current touch scenario is the daily scenario, the application end of the non-full-screen gesture scenario or the application end of the full-screen gesture scenario acquires the touch filtering parameter value corresponding to the touch scenario from the pre-stored correspondence between the scenario identification and the touch filtering parameter value on the basis of the scenario identification of the touch scenario.

The operation 406: the terminal obtaining the second touch operation by performing the filtering process on the first touch operation on the basis of the touch filtering parameter value.

In some embodiments, this operation is identical to the operation 103, and thus is not elaborated herein.

The operation 407: the terminal responding to the second touch operation.

In some embodiments, this operation is identical to the operation 104, and thus is not elaborated herein. For example, please continue to refer to FIG. 2. In a case where the first touch operation is detected, the terminal calculates the position coordinates of the first touch operation through the touch coordinate calculation module, and transmits the position coordinates to the application end of the non-full-screen gesture scenario or the application end of the full-screen gesture scenario. The application end of the non-full-screen gesture scenario or the application end of the full-screen gesture scenario obtains the second touch operation by performing the filtering process on the first touch operation on the basis of the position coordinates and the touch filtering parameter value, and subsequently responds to the second touch operation.

In other embodiments, the touch coordinate calculation module does not synchronize the correspondence between the scenario identification and the touch filtering parameter value to the application end of the non-full-screen gesture scenario or the application end of the full-screen gesture scenario. In a case where the first touch operation is received, the touch coordinate calculation module determines the touch filtering parameter value corresponding to the touch scenario from the correspondence between the scenario identification and the touch filtering parameter value on the basis of the scenario identification of the touch scenario, and obtains the second touch operation by performing the filtering process on the first touch operation on the basis of the touch filtering parameter value.

In the embodiments of the present disclosure, the terminal determines the touch filtering parameter values of the user in a plurality of touch scenarios in advance on the basis of the historical touch data of the user. The touch filtering parameter values determined in this manner are better adapted to the user. Consequently, on the basis of the touch scenario corresponding to the first touch operation, the acquired touch filtering parameter value is adapted not only to the current touch scenario but also to the user. The accuracy of the acquired touch filtering parameter value may be improved, thereby enhancing the effect of the performing filtering process on the first touch operation on the basis of the touch filtering parameter value, and further improving the effect of the second touch operation obtained by responding.

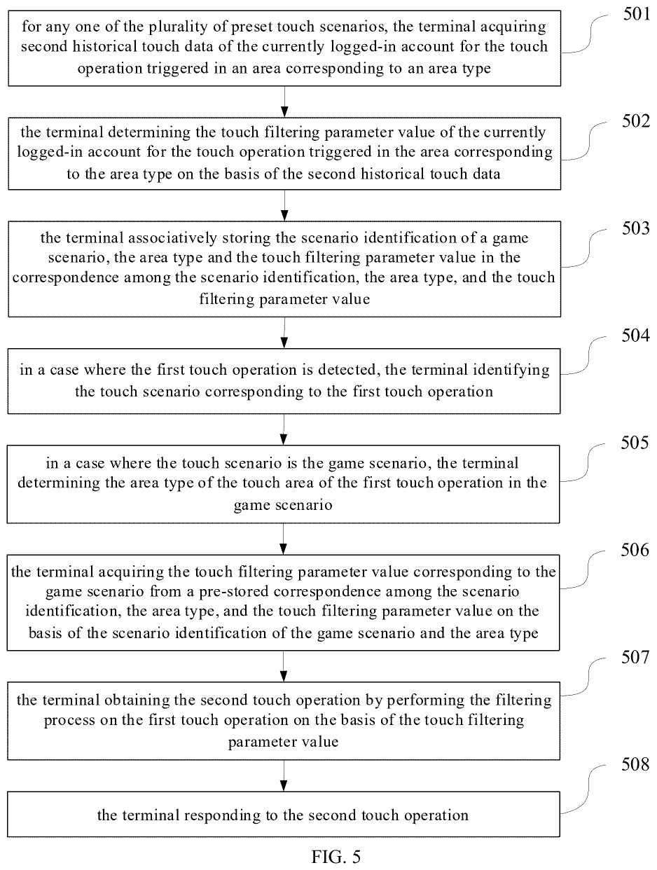

Please refer to FIG. 5, which illustrates a schematic flowchart of a touch response method according to an exemplary embodiment of the present disclosure. The method includes:

The operation 501: for any one of the plurality of preset touch scenarios, the terminal acquiring second historical touch data of the currently logged-in account for the touch operation triggered in an area corresponding to an area type.

The area type refers to a type corresponding to a touch area. For example, the area type may be a game display type, a function selection type, a game operation type, etc. The game display type indicates that the touch area is used for displaying a game interface. The function selection type indicates that the touch area is used for selecting functions such as equipment. The game operation type indicates that the touch area is used for controlling operations such as virtual object movement. The terminal records the historical touch data of the touch operation historically triggered by the user, and the historical touch data include the area type of the touch area triggered by the user. For any area type, the terminal acquires the second historical touch data of the currently logged-in account for the touch operation triggered in the area corresponding to the area type.

The operation 502: the terminal determining the touch filtering parameter value of the currently logged-in account for the touch operation triggered in the area corresponding to the area type on the basis of the second historical touch data.

The touch filtering parameter value includes the touch-point filtering parameter value and the trajectory filtering parameter value. Correspondingly, in this operation, the terminal determines the touch-point filtering parameter value on the basis of the touch data corresponding to the click operation in the second historical touch data, and determines the trajectory filtering parameter value on the basis of the touch data corresponding to the sliding operation in the second historical touch data.

The second historical touch data include touch data corresponding to a plurality of click operations. For any click operation, the touch data corresponding to the click operation include position coordinates of a touch area. The terminal determines the distance between the center touch-point and the edge touch-point of the touch area on the basis of the position coordinates of the touch area corresponding to the click operation, determines the average distance on the basis of the distances between the center touch-points and the edge touch-points corresponding to the plurality of click operations, and determines the touch-point filtering parameter value on the basis of the average distance. For example, the terminal takes the average distance as the touch-point filtering parameter value. Alternatively, the terminal obtains the touch-point filtering parameter value by floating the average distance upward to a third preset distance, or obtains the touch-point filtering parameter value by floating the average distance downward to a fourth preset distance. Both the third preset distance and the fourth preset distance may be set and modified as necessary. In the embodiments of the present disclosure, the third preset distance and the fourth preset distance are not specifically limited.

The second historical touch data include touch data corresponding to a plurality of sliding operations. For any sliding operation, the touch data corresponding to the sliding operation include the sliding trajectory. The terminal determines the smoothness of the sliding trajectory of the sliding operation, determines the average smoothness of the smoothness corresponding to the plurality of sliding operations, and determines the trajectory filtering parameter value on the basis of the average smoothness. For example, the terminal may obtain the trajectory filtering parameter value by determining the ratio of the preset smoothness to the average smoothness.

In the embodiments of the present disclosure, in the game scenario, the terminal identifies the current usage scenario of the user via image recognition, determines whether it is a clicking scenario or a sliding scenario, and accordingly adjusts our lock-points and filtering parameters. Furthermore, the terminal performs tracking for each ID, thereby resolving experience issues of the user such as lift-off jitter, unresponsive clicks, and poor follow-up feeling during sliding operations.

The operation 503: the terminal associatively storing the scenario identification of a game scenario, the area type and the touch filtering parameter value in a correspondence among the scenario identification, the area type, and the touch filtering parameter value.

In some embodiments, the operations 501-503 may be executed only once. Subsequently, in a case where the first touch operation is detected, operations 504-507 may be executed directly. In other embodiments, the terminal executes the operations 501-503 periodically at a preset interval, thereby enabling timely updates of the touch filtering parameter value. Therefore, the touch filtering parameter value may remain current, and the accuracy of the touch filtering parameter value may be improved.

The operation 504: in a case where the first touch operation is detected, the terminal identifying the touch scenario corresponding to the first touch operation.

In some embodiments, this operation is identical to the operation 101, and thus is not elaborated herein.

The operation 505: in a case where the touch scenario is the game scenario, the terminal determining the area type of the touch area of the first touch operation in the game scenario.

The terminal obtains a scenario image by capturing a screenshot of the game scenario, identifies a core icon of the scenario image through an image identification model, and determines the area type corresponding to the core icon. The scenario image refers to an image including scenario identification information. For example, the scenario image may be a game interface. The core icon refers to an icon including area identification information. For example, the core icon may be a function option name, etc. The image identification model may be an object detection model. The core icon may be located and identified through the object detection model to determine the area type of the touch area. Different core icons correspond to different area types. For example, a core icon 1 corresponds to an area type 1,and a core icon 2 corresponds to an area type 2.

The operation 506: the terminal acquiring the touch filtering parameter value corresponding to the game scenario from a pre-stored correspondence among the scenario identification, the area type, and the touch filtering parameter value on the basis of the scenario identification of the game scenario and the area type.

For example, continuing to refer to FIG. 2. In a case where the terminal identifies that the touch scenario corresponding to the first touch operation is the game scenario, the terminal performs a scenario identification on a game screenshot, and distinguishes the scenario to identify which type of game scenario it is, that is, to identify the area type of the game scenario. In some embodiments, a game application end of the terminal obtains the scenario image by capturing a screenshot of the game scenario, and transmits the scenario image to a game engine. The game engine determines the area type through an image recognition model. The game engine then transmits the determined area type to a driver service. The driver service acquires the touch filtering parameter value corresponding to the game scenario from the pre-stored correspondence among the scenario identification, the area type, and the touch filtering parameter value (a touch algorithm library), on the basis of the scenario identification of the game scenario and the area type. In some embodiments, the touch algorithm library is responsible for coordinate calculation and the filtering process of the touch operation. For example, in a case where the MCU of the terminal detects the first touch operation, the touch algorithm library determines the position coordinates of the first touch operation, and transmits the position coordinates of the first touch operation to the driver service.

The operation 507: the terminal obtaining the second touch operation by performing the filtering process on the first touch operation on the basis of the touch filtering parameter value.

In some embodiments, this operation is identical to the operation 103, and thus is not elaborated herein.

The operation 508: the terminal responding to the second touch operation.

In some embodiments, this operation is identical to the operation 104, and thus is not elaborated herein.

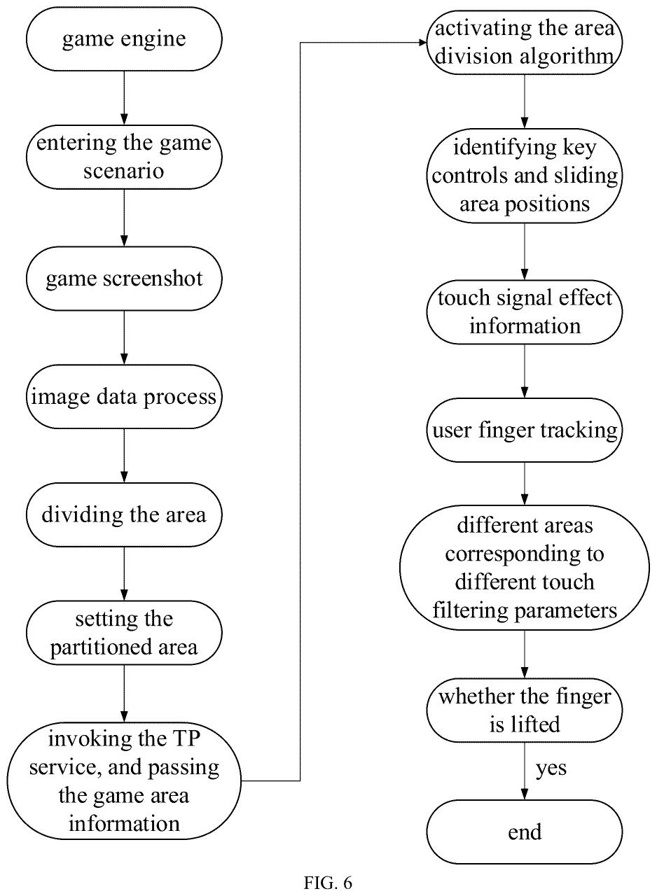

For example, please refer to FIG. 6. The game engine of the terminal enters the game scenario, then obtains the scenario image by capturing a screenshot of the game scenario, and identifies the core icon of the scenario image through image data process. The game engine divides an area of the game scenario on the basis of the core icon, thereby achieving the setting of the partitioned area. At this point, the terminal invokes a touch service, passing in the partitioned area, and then activates an area division algorithm. The terminal identifies the core icon through the area division algorithm, and determines the area type on the basis of the core icon. In a case where the first touch operation (touch signal effect information) is received, the terminal tracks a finger of the user, and determines the corresponding touch filtering parameter value on the basis of the area type. In a case where the finger is lifted, the terminal performs the filtering process on the first touch operation on the basis of the touch filtering parameter value, and then responds to the obtained the second touch operation, concluding the process.

In the embodiments of the present disclosure, the terminal determines the touch filtering parameter values corresponding to different area types in the game scenario for the user in advance, on the basis of the historical touch data of the user. The touch filtering parameter values determined in this manner are better adapted to both the user and the current area type. Consequently, on the basis of the game scenario and the area type of the touch area corresponding to the first touch operation, the acquired touch filtering parameter value is adapted not only to the user but also to the area type in the game scenario. The accuracy of the acquired touch filtering parameter value may be improved, thereby enhancing the effect of performing the filtering process on the first touch operation on the basis of the touch filtering parameter value, and further improving the effect of the second touch operation obtained by responding.

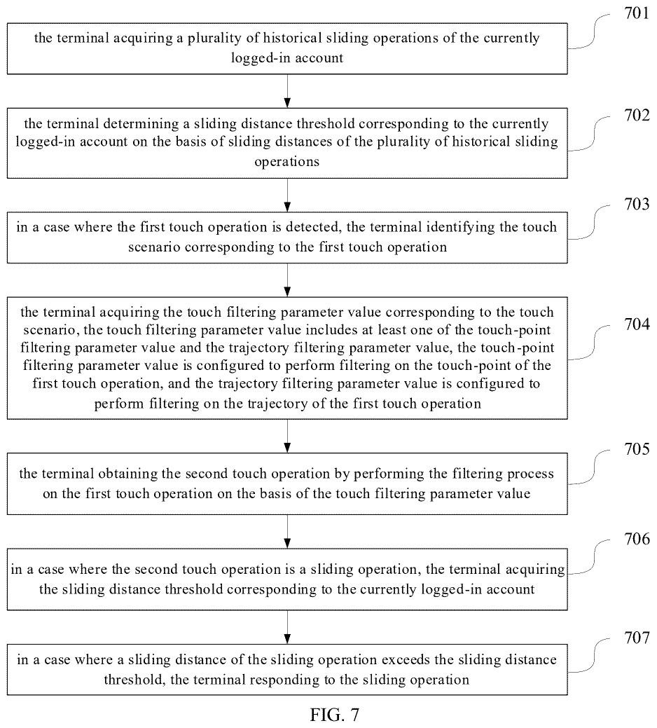

Please refer to FIG. 7, which illustrates a schematic flowchart of a touch response method according to an exemplary embodiment of the present disclosure. The method includes:

The operation 701: the terminal acquiring a plurality of historical sliding operations of the currently logged-in account.

Embodiments of the present disclosure may be applied in a target scenario. The target scenario may be the game scenario or the daily scenario. In this operation, the description is provided using the target scenario as the daily scenario. The target scenario may be the game scenario or the daily scenario. The daily scenario may be also divided into the full-screen gesture scenario (which may also be referred to as the full-screen daily scenario) and the non-full-screen gesture scenario (which may also be referred to as the non-full-screen daily scenario). Thus, the target scenario may be the full-screen gesture scenario. For example, please continue to refer to FIG. 2, a user interface (UI) sliding database is stored in the terminal. The UI sliding database stores the plurality of historical sliding operations of the currently logged-in account in the target scenario. The terminal acquires the plurality of historical sliding operations from the UI sliding database.

The operation 702: the terminal determining a sliding distance threshold corresponding to the currently logged-in account on the basis of sliding distances of the plurality of historical sliding operations.

The terminal determines an average sliding distance on the basis of the sliding distances of the plurality of historical sliding operations, and determines the sliding distance threshold on the basis of the average sliding distance. For example, the terminal takes the average sliding distance as the sliding distance threshold. Alternatively, the terminal obtains the sliding distance threshold by floating the average sliding distance upward to a fifth preset distance, or obtains the sliding distance threshold by floating the average sliding distance downward to a sixth preset distance. Both the fifth preset distance and the sixth preset distance may be set and modified as necessary. In the embodiments of the present disclosure, the fifth preset distance and the sixth preset distance are not specifically limited.

In the embodiments of the present disclosure, in the full-screen gesture scenario, the terminal records the sliding distances of a user's daily habitual full-screen multi-tasking operations, and calibrates the sliding distance applicable to the UI for multi-tasking, thereby enabling each user to achieve a better follow-up feeling experience.

The operation 703: in a case where the first touch operation is detected, the terminal identifying the touch scenario corresponding to the first touch operation.

In some embodiments, this operation is identical to the operation 101, and thus is not elaborated herein.

The operation 704: the terminal acquiring the touch filtering parameter value corresponding to the touch scenario, the touch filtering parameter value includes at least one of the touch-point filtering parameter value and the trajectory filtering parameter value, the touch-point filtering parameter value is configured to perform filtering on the touch-point of the first touch operation, and the trajectory filtering parameter value is configured to perform filtering on the trajectory of the first touch operation.

In some embodiments, this operation is identical to the operation 102, and thus is not elaborated herein. Alternatively, this operation is identical to operation 405, and thus is not elaborated herein. In other embodiments, after identifying the touch scenario, the terminal acquires the touch filtering parameter value corresponding to the touch scenario only in a case where the terminal determines that the touch scenario is the target scenario.

The operation 705: the terminal obtaining the second touch operation by performing the filtering process on the first touch operation on the basis of the touch filtering parameter value.

In some embodiments, this operation is identical to the operation 103, and thus is not elaborated herein.

The operation 706: in a case where the second touch operation is a sliding operation, the terminal acquiring the sliding distance threshold corresponding to the currently logged-in account.

In a case where the embodiments of the present disclosure are applied to the target scenario, this operation may be as follows: in a case where the touch scenario is the target scenario and the second touch operation is the sliding operation, the terminal acquires the sliding distance threshold corresponding to the currently logged-in account.

The terminal may obtain the sliding distance threshold corresponding to the currently logged-in account, and store the sliding distance threshold corresponding to the currently logged-in account, through the operations 701-702. In this operation, the terminal directly acquires a pre-stored sliding distance threshold corresponding to the currently logged-in account, and then execute the operation 707.

The operation 707: in a case where a sliding distance of the sliding operation exceeds the sliding distance threshold, the terminal responding to the sliding operation.

The terminal determines the second touch instruction corresponding to the sliding operation on the basis of the touch scenario, and executes the second touch instruction to respond to the second touch operation. For example, in a case where the touch scenario is the full-screen gesture scenario and the user is browsing short videos, the second touch operation triggered by the user is intended to trigger the switch instruction for the terminal, then the terminal switches the currently playing short video on the basis of the switch instruction.

In some embodiments, in a case where the sliding distance of the sliding operation does not exceed the sliding distance threshold, the terminal does not respond to the sliding operation. Additionally, the terminal may also display a prompt message. The prompt message is configured to indicate the sliding distance threshold to inform the user that the sliding distance should exceed the sliding distance threshold, in a case where the user intends to trigger an instruction for the terminal through the sliding operation.

In the embodiments of the present disclosure, the terminal may not only set the touch-point filtering parameter (lock-point parameter) and the trajectory filtering parameter (follow-up feeling parameter) for different users, but also identify and adjust the sliding distance threshold in the full-screen scenario. Furthermore, the terminal may identify the same scenario across different games, and adjust different touch-point filtering parameters (lock-point parameters) and trajectory filtering parameters (follow-up feeling parameters), thereby comprehensively enhancing the touch experience of the user.

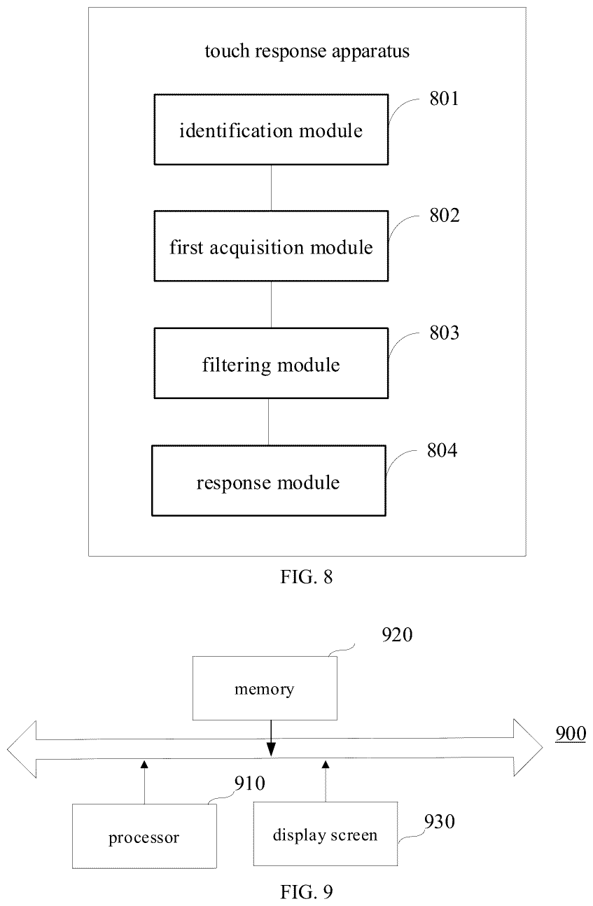

Please refer to FIG. 8, which illustrates a block diagram of a touch response apparatus according to an exemplary embodiment of the present disclosure. The apparatus includes:

An identification module 801, configured to identify a touch scenario corresponding to a first touch operation in a case where the first touch operation is detected.

A first acquisition module 802, configured to acquire a touch filtering parameter value corresponding to the touch scenario. The touch filtering parameter value includes at least one of a touch-point filtering parameter value and a trajectory filtering parameter value. The touch-point filtering parameter value is configured to perform filtering on a touch-point of the first touch operation. The trajectory filtering parameter value is configured to perform filtering on a trajectory of the first touch operation.

A filtering module 803, configured to obtain a second touch operation by performing a filtering process on the first touch operation on the basis of the touch filtering parameter value.

A response module 804, configured to respond to the second touch operation.

In some embodiments, the first acquisition module 802 is configured to acquire the touch filtering parameter value corresponding to the touch scenario from a pre-stored correspondence between a scenario identification and the touch filtering parameter value on the basis of the scenario identification of the touch scenario.

In some embodiments, the apparatus further includes:

A second acquisition module, configured to, for any one of a plurality of preset touch scenarios, acquire first historical touch data of a currently logged-in account in the touch scenario.

A first determination module, configured to determine the touch filtering parameter value of the currently logged-in account in the touch scenario on the basis of the first historical touch data.

A first storage module, configured to associatively store the scenario identification of the touch scenario and the touch filtering parameter value in the correspondence between the scenario identification and the touch filtering parameter value.

In some embodiments, the first acquisition module 802 is configured to determine an area type of a touch area of the first touch operation in a game scenario in a case where the touch scenario is the game scenario; and acquire the touch filtering parameter value corresponding to the game scenario from a pre-stored correspondence among the scenario identification, the area type, and the touch filtering parameter value on the basis of the scenario identification of the game scenario and the area type.

In some embodiments, the first acquisition module 802 is configured to obtain a scenario image by capturing a screenshot of the game scenario, identify a core icon of the scenario image through an image recognition model, and determine the area type corresponding to the core icon.

In some embodiments, the apparatus further includes:

A third acquisition module, configured to, for any one of a plurality of preset area types in the game scenario, acquire second historical touch data of the currently logged-in account for touch operation triggered in an area corresponding to the area type.

A second determination module, configured to determine the touch filtering parameter value of the currently logged-in account for the touch operation triggered in the area corresponding to the area type on the basis of the second historical touch data.

A second storage module, configured to associatively store the scenario identification of the game scenario, the area type, and the touch filtering parameter value in the correspondence among the scenario identification, the area type, and the touch filtering parameter value.

In some embodiments, the response module 804 is configured to acquire a sliding distance threshold corresponding to the currently logged-in account in a case where the second touch operation is a sliding operation, and respond to the sliding operation in a case where a sliding distance of the sliding operation exceeds the sliding distance threshold.

In some embodiments, the apparatus further includes:

A fourth acquisition module, configured to acquire a plurality of historical sliding operations of the currently logged-in account.

A third determination module, configured to determine the sliding distance threshold corresponding to the currently logged-in account on the basis of sliding distances of the plurality of historical sliding operations.

In some embodiments, the filtering module 803 is configured for a case where the touch filtering parameter value includes the touch-point filtering parameter value. In a case where a distance between an edge touch-point and a center touch-point of the first touch operation is less than a touch-point distance threshold represented by the touch-point filtering parameter value, the second touch operation obtained by performing the filtering process on the first touch operation is a click operation. In a case where the distance between the edge touch-point and the center touch-point of the first touch operation is not less than the touch-point distance threshold represented by the touch-point filtering parameter value, the second touch operation obtained by performing the filtering process on the first touch operation is the sliding operation.

In some embodiments, the filtering module 803 is configured for a case where the touch filtering parameter value includes the trajectory filtering parameter value, and to obtain the second touch operation by performing the smoothing process on a sliding trajectory of the first touch operation on the basis of the trajectory filtering parameter value.

In the embodiments of the present disclosure, different touch filtering parameter values corresponding to different touch scenarios are set, so that the touch filtering parameter value adaptive to the current touch scenario may be acquired. That is, the acquired touch filtering parameter value is more rational. Therefore, the effect of performing the filtering process on the first touch operation on the basis of the touch filtering parameter value may be improved, thereby further improving the effect of responding to the obtained second touch operation.

It should be noted that, in case where the touch response apparatus provided by the above-mentioned embodiments is performing touch response, the division of the above-mentioned functional modules is merely used as examples for description. In practical applications, the above-mentioned functions may be allocated to be completed by different functional modules as needed. That is, the internal structure of the terminal may be divided into different functional modules to complete all or part of the functions described above. Furthermore, the touch response apparatus provided in the above-mentioned embodiments and the touch response method embodiments share the same inventive concept. For the specific implementation process, please refer to the method embodiments. No further details will be provided herein.

Please refer to FIG. 9, which illustrates a block diagram of a terminal 900 according to an exemplary embodiment of the present disclosure. The terminal 900 in the present disclosure includes one or more of the following components: a processor 910, a memory 920, and a display screen 930.

The processor 910 may include one or more processing cores. The processor 910 is connected to various parts throughout the terminal 900 via various interfaces and lines, and executes various functions of the terminal 900 and processes data by running or executing instructions, programs, code sets, or instruction sets stored in the memory 920 and invoking data stored in the memory 920. In some embodiments, the processor 910 may be implemented using at least one hardware form of Digital Signal Processing (DSP), Field-Programmable Gate Array (FPGA), and Programmable Logic Array (PLA). The processor 910 may integrate one or a combination of several of the following: a Central Processing Unit (CPU), a Graphics Processing Unit (GPU), a Neural-network Processing Unit (NPU), and a modem, etc. In some embodiments, the CPU primarily handles the operating system, user interface, and applications, etc. The GPU is configured to be responsible for rendering and drawing content to be displayed on the display screen 930. The NPU is configured to implement Artificial Intelligence (AI) functions. The modem is configured to handles wireless communications. It should be understood that the above-mentioned modem may also not be integrated into the processor 910 and implemented separately via a chip.

The memory 920 may include a Random Access Memory (RAM), and may also include a Read-Only Memory. In some embodiments, the memory 920 includes a non-transitory computer-readable storage medium. The memory 920 may be configured to store instructions, programs, code, code sets, or instruction sets. The memory 920 may include a program storage area and a data storage area. In some embodiments, the program storage area may store instructions for implementing an operating system, instructions for at least one function (such as touch function, sound playback function, image playback function, etc.), and instructions for implementing various method embodiments described below, etc. The data storage area may store data created through the use of the terminal 900 (such as audio data and phone book), etc.

The display screen 930 is a display component configured to display a user interface. In some embodiments, the display screen 930 is a display screen with touch function. Through the touch function, the user may perform a touch operation on the display screen 930 using any suitable object such as a finger or a touch pen, etc.

The display screen 930 is typically disposed on the front panel of the terminal 900. The display screen 930 may be designed as a full screen, a curved screen, a special-shaped screen, a dual screen, or a foldable screen. The display screen 930 may also be designed as a combination of the full screen and the curved screen, or a combination of the special-shaped screen and the curved screen, etc., which is not limited in this embodiment.

In addition, those skilled in the art may appreciate that the structure of the terminal 900 illustrated in the above-mentioned drawings does not limit the terminal 900. The terminal 900 may include more or fewer components than those illustrated in the drawings, combine some components, or have a different arrangement of components. For example, the terminal 900 may further include an audio capture device, a speaker, a radio frequency circuit, an input unit, a sensor, an audio circuit, a Wireless Fidelity (Wi-Fi) module, a power supply, a Bluetooth module, and other components, which will not be elaborated herein.

Embodiments of the present disclosure further provide a non-transitory computer-readable medium. The non-transitory computer-readable medium stores at least one piece of program code. The at least one piece of program code is loaded and executed by the processor to implement the touch response method illustrated in the various embodiments above.

Embodiments of the present disclosure further provide a computer program product. The computer program product stores at least one piece of program code. The at least one piece of program code is loaded and executed by the processor to implement the touch response method illustrated in the various embodiments above.

In some embodiments, the computer program product involved in the embodiments of the present disclosure may be deployed to be executed on one single terminal, on multiple terminals located at one single site, or, alternatively, on multiple terminals distributed across multiple sites and interconnected via a communication network. The multiple terminals distributed across multiple sites and interconnected via the communication network may constitute a blockchain system.

Those skilled in the art may appreciate that, in one or multiple of the above-mentioned examples, the functions described in the embodiments of the present disclosure may be implemented in hardware, software, firmware, or any combination thereof. In a case where the functions are implemented in software, the functions may be stored in the non-transitory computer-readable medium, or may be transmitted as one or more instructions or code on the non-transitory computer-readable medium. The non-transitory computer-readable medium includes a computer storage medium and a communication medium. In some embodiments, the communication medium includes any medium that facilitates transmission of a computer program from one place to another place. The storage medium may be any available medium that may be accessed by a general-purpose or special-purpose computer.

The above descriptions are merely some embodiments of the present disclosure, and are not configured to limit the present disclosure. Any modification, equivalent substitution, or improvement made within the spirit and principles of the present disclosure shall fall within the protection scope of the present disclosure.

1. A touch response method, comprising:
in case where a first touch operation is detected, identifying a touch scenario corresponding to the first touch operation;
acquiring a touch filtering parameter value corresponding to the touch scenario, wherein the touch filtering parameter value comprises at least one of a touch-point filtering parameter value and a trajectory filtering parameter value, the touch-point filtering parameter value is configured to perform filtering on a touch-point of the first touch operation, the trajectory filtering parameter value is configured to perform filtering on a trajectory of the first touch operation;
obtaining a second touch operation by performing a filtering process on the first touch operation on the basis of the touch filtering parameter value; and
responding to the second touch operation.

2. The method as claimed in claim 1, wherein the acquiring the touch filtering parameter value corresponding to the touch scenario, comprises:
acquiring the touch filtering parameter value corresponding to the touch scenario from a pre-stored correspondence between a scenario identification and the touch filtering parameter value on the basis of the scenario identification of the touch scenario.

3. The method as claimed in claim 2, further comprising:
for any one of a plurality of preset touch scenarios, acquiring first historical touch data of a currently logged-in account in the touch scenario;
determining the touch filtering parameter value of the currently logged-in account in the touch scenario on the basis of the first historical touch data; and
associatively storing the scenario identification of the touch scenario and the touch filtering parameter value in the correspondence between the scenario identification and the touch filtering parameter value.

4. The method as claimed in claim 2, wherein the acquiring the touch filtering parameter value corresponding to the touch scenario from the pre-stored correspondence between the scenario identification and the touch filtering parameter value on the basis of the scenario identification of the touch scenario, comprises:
in a case where the touch scenario is a game scenario, determining an area type of a touch area of the first touch operation in the game scenario; and
acquiring the touch filtering parameter value corresponding to the game scenario from a pre-stored correspondence among the scenario identification, the area type, and the touch filtering parameter value on the basis of the scenario identification of the game scenario and the area type.

5. The method as claimed in claim 4, wherein the determining the area type of the touch area of the first touch operation in the game scenario, comprises:
obtaining a scenario image by capturing a screenshot of the game scenario;
identifying a core icon of the scenario image through an image identification model; and
determining the area type corresponding to the core icon.

6. The method as claimed in claim 4, further comprising:
for any one of a plurality of preset area types in the game scenario, acquiring second historical touch data of the currently logged-in account for the touch operation triggered in an area corresponding to the area type;
determining the touch filtering parameter value of the currently logged-in account for the touch operation triggered in the area corresponding to the area type on the basis of the second historical touch data; and
associatively storing the scenario identification of the game scenario, the area type, and the touch filtering parameter value in the correspondence among the scenario identification, the area type, and the touch filtering parameter value.

7. The method as claimed in claim 1, wherein the responding to the second touch operation, comprises:
in a case where the second touch operation is a sliding operation, acquiring a sliding distance threshold corresponding to the currently logged-in account; and
in a case where a sliding distance of the sliding operation exceeds the sliding distance threshold, responding to the sliding operation.

8. The method as claimed in claim 7, further comprising:
acquiring a plurality of historical sliding operations of the currently logged-in account; and
determining the sliding distance threshold corresponding to the currently logged-in account on the basis of sliding distances of the plurality of historical sliding operations.

9. The method as claimed in claim 1, wherein the obtaining the second touch operation by performing the filtering process on the first touch operation on the basis of the touch filtering parameter value, comprises:
the touch filtering parameter value comprises the touch-point filtering parameter value; in a case where a distance between an edge touch-point and a center touch-point of the first touch operation is less than a touch-point distance threshold represented by the touch-point filtering parameter value, the second touch operation obtained by performing the filtering process on the first touch operation is a click operation; and
in a case where the distance between the edge touch-point and the center touch-point of the first touch operation is not less than the touch-point distance threshold represented by the touch-point filtering parameter value, the second touch operation obtained by performing the filtering process on the first touch operation is a sliding operation.

10. The method as claimed in claim 1, wherein the obtaining the second touch operation by performing the filtering process on the first touch operation on the basis of the touch filtering parameter value, comprises:
the touch filtering parameter value comprises the trajectory filtering parameter value; obtaining the second touch operation by performing a smoothing process on a sliding trajectory of the first touch operation on the basis of the trajectory filtering parameter value.

11. The method as claimed in claim 1, wherein the identifying the touch scenario corresponding to the first touch operation, comprises:
identifying the touch scenario corresponding to the first touch operation through an application running in a foreground;
in a case where the application currently running in the foreground is a game application, determining that the touch scenario corresponding to the first touch operation is a game scenario; and
in a case where the application currently running in the foreground is a non-game application, determining that the touch scenario corresponding to the first touch operation is a daily scenario.

12. The method as claimed in claim 11, wherein after determining that the touch scenario corresponding to the first touch operation is the daily scenario, the method further comprises:
determining whether a full-screen gesture is enabled on a terminal;
in a case where the full-screen gesture is enabled on the terminal, determining the touch scenario corresponding to the first touch operation is a full-screen gesture scenario; and
in a case where a non-full-screen gesture is enabled on the terminal, determining the touch scenario corresponding to the first touch operation is a non-full-screen gesture scenario.

13. The method as claimed in claim 1, wherein the identifying the touch scenario corresponding to the first touch operation, further comprises:
identifying the touch scenario corresponding to the first touch operation through a scenario identification model;
obtaining an interface screenshot by capturing a screenshot of an interface currently displayed; and
inputting the interface screenshot into the scenario identification model to output the touch scenario corresponding to the first touch operation.

14. The method as claimed in claim 3, wherein the determining the touch filtering parameter value of the currently logged-in account in the touch scenario on the basis of the first historical touch data, comprises:
the first historical touch data comprise touch data corresponding to a click operation and touch data corresponding to a sliding operation;
determining a touch-point filtering parameter value of the touch filtering parameter value on the basis of the touch data corresponding to the click operation; and
determining a trajectory filtering parameter value of the touch filtering parameter value on the basis of the touch data corresponding to the sliding operation.

15. The method as claimed in claim 14, wherein the determining the touch-point filtering parameter value of the touch filtering parameter value on the basis of the touch data corresponding to the click operation, comprises:
the first historical touch data comprise touch data corresponding to a plurality of click operations;
for any click operation, the touch data corresponding to the click operation comprise position coordinates of the touch area;
determining a distance between a center touch-point and an edge touch-point of the touch area on the basis of the position coordinates of the touch area corresponding to the click operation;
determining an average distance on the basis of distances between center touch-points and edge touch-points corresponding to the plurality of click operations; and
determining the touch-point filtering parameter value on the basis of the average distance.

16. The method as claimed in claim 14, wherein the determining the trajectory filtering parameter value of the touch filtering parameter value on the basis of the touch data corresponding to the sliding operation, comprises:
the first historical touch data comprise touch data corresponding to a plurality of sliding operations;
for any sliding operation, the touch data corresponding to the sliding operation comprise a sliding trajectory;
determining a smoothness of the sliding trajectory of the sliding operation;
determining an average smoothness of smoothness corresponding to the plurality of sliding operations; and
determining the trajectory filtering parameter value on the basis of the average smoothness.

17. A terminal, comprising one or more processors and one or more memories, wherein at least one piece of program code is stored in the one or more memories, and the at least one piece of program code is loaded and executed by the one or more processors to implement a touch response method;
wherein the touch response method comprises:
in case where a first touch operation is detected, identifying a touch scenario corresponding to the first touch operation;
acquiring a touch filtering parameter value corresponding to the touch scenario, wherein the touch filtering parameter value comprises at least one of a touch-point filtering parameter value and a trajectory filtering parameter value, the touch-point filtering parameter value is configured to perform filtering on a touch-point of the first touch operation, the trajectory filtering parameter value is configured to perform filtering on a trajectory of the first touch operation;
obtaining a second touch operation by performing a filtering process on the first touch operation on the basis of the touch filtering parameter value; and
responding to the second touch operation.

18. The terminal as claimed in claim 17, wherein the acquiring the touch filtering parameter value corresponding to the touch scenario, comprises:
acquiring the touch filtering parameter value corresponding to the touch scenario from a pre-stored correspondence between a scenario identification and the touch filtering parameter value on the basis of the scenario identification of the touch scenario.

19. A non-transitory computer-readable storage medium, wherein at least one piece of program code is stored in the non-transitory computer-readable storage medium, and the at least one piece of program code is loaded and executed by a processor to implement a touch response method;
wherein the touch response method comprises:
in case where a first touch operation is detected, identifying a touch scenario corresponding to the first touch operation;
acquiring a touch filtering parameter value corresponding to the touch scenario, wherein the touch filtering parameter value comprises at least one of a touch-point filtering parameter value and a trajectory filtering parameter value, the touch-point filtering parameter value is configured to perform filtering on a touch-point of the first touch operation, the trajectory filtering parameter value is configured to perform filtering on a trajectory of the first touch operation;
obtaining a second touch operation by performing a filtering process on the first touch operation on the basis of the touch filtering parameter value; and responding to the second touch operation.

20. The non-transitory computer-readable storage medium as claimed in claim 19, wherein the acquiring the touch filtering parameter value corresponding to the touch scenario, comprises:
acquiring the touch filtering parameter value corresponding to the touch scenario from a pre-stored correspondence between a scenario identification and the touch filtering parameter value on the basis of the scenario identification of the touch scenario.
